(19) United States
(12) Patent Application Publication
(10) Pub. No.: US 2024/0169376 A1
(43) Pub. Date: May 23, 2024

(54) DYNAMIC VERTICAL SEGMENTED DATA TRANSMISSION

(71) Applicant: International Business Machines Corporation, Armonk, NY (US)

(72) Inventors: LING MA, BeiJing (CN); Cheng Fang Wang, Beijing (CN); Jing Yan ZZ Zhang, BeiJing (CN); Bing Qian, Beijing (CN); Wen Wen Guo, Beijing (CN); Bo Chen Zhu, Xi'an (CN)

(21) Appl. No.: 17/993,087

(22) Filed: Nov. 23, 2022

(51) Int. Cl. G06Q 30/0202; G06Q 10/0639

(52) U.S. Cl. CPC G06Q 30/0202; G06Q 10/06393

(57) ABSTRACT

An approach is disclosed that receives an incoming data record, the data record including a number of data fields. The approach determines a current Real-Time Resources Score (RTRS). The RTRS being a forecast of the information handling system's ability to handle incoming data transmissions. When the RTRS is lower than a current data accumulation rate, a subset of the data record is sent based on field priorities. The approach assigns priorities to each of the data fields included in the data record based on a priority assessment of the respective data fields. The approach then sends, to a data receiver, a subset of the plurality of data fields based on the assigned priority.

### BACKGROUND

Traditionally, in common data provider, transfer and consumer model, when the network has limitations or when the target consumer has difficulty handling all of the incoming data, some data will be delayed or lost. This delay or lost can also prevent key data from arriving. Because of data delay and loss, the target business can be impacted. In order to avoid business impacts, one approach is to reduce the density and accuracy of the incoming data through sequencing as well as horizontally discarding some data fragments in order to meet the consumers' needs.

### SUMMARY

An approach is disclosed that receives an incoming data record, the data record including a number of data fields. The approach determines a current Real-Time Resources Score (RTRS). The RTRS being a forecast of the information handling system's ability to handle incoming data transmissions. When the RTRS is lower than a current data accumulation rate, a subset of the data record is sent based on field priorities. The approach assigns priorities to each of the data fields included in the data record based on a priority assessment of the respective data fields. The approach then sends, to a data receiver, a subset of the plurality of data fields based on the assigned priority.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram depicting components used in a dynamic vertical segmented data transmission process;

FIG. 4 is a flowchart depicting steps taken in a vertical data priority division process to configure data priority;

FIG. 5 is a flowchart depicting steps taken in a vertical data priority division process to split data based on priority;

FIG. 6 is a flowchart depicting the steps taken by a resource state analyzer process to calculate a Real-Time Resources Score (RTRS) metric;

FIG. 7 is a flowchart depicting steps taken in a data sending decision process; and

FIG. 8 is a flowchart depicting steps taken in a priority assessment process called by the data sending decision process.

### DETAILED DESCRIPTION

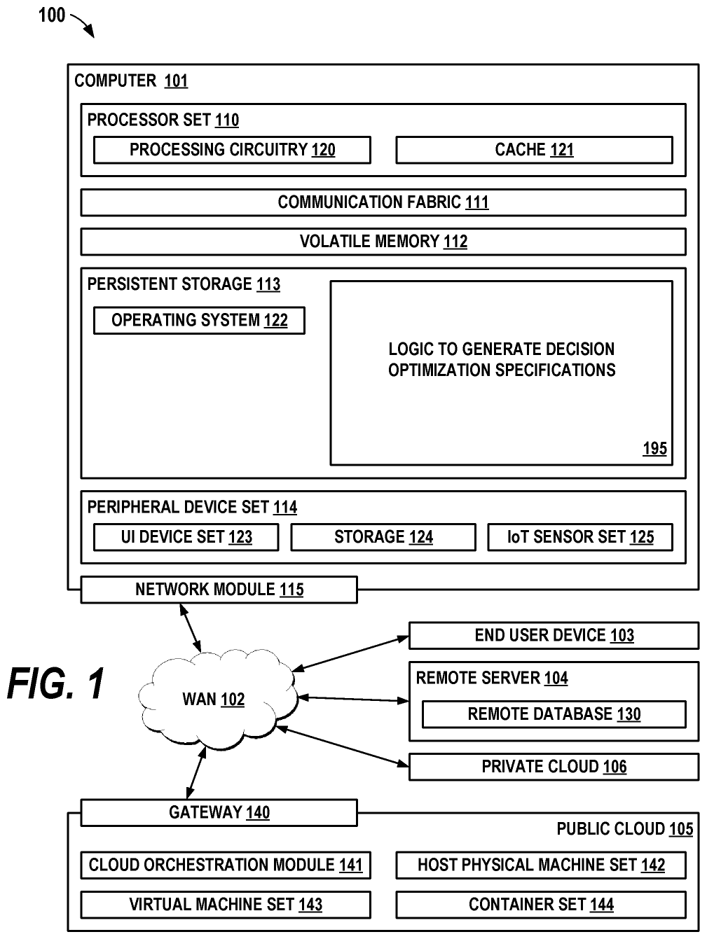

FIGS. 1-8 describe an approach for a dynamic vertical data flow segmentation. According to the business requirements of the consumer, some key data are extracted from the full amount of data, and the key data is transmitted first at the data sending end. When the network bandwidth or the performance of the consumer is restored, other data is transmitted, so that data is not lost as a whole and to minimize the effect on the business and customer experience.

Considering that multiple consumers have different requirements, in this approach, the dynamic vertical segmentation of data is realized at the sending end. This method includes the following modules:

1. Detect model: This module can detect and diagnose the capability of the network or consumer, send signals to the data sender to switch to the key data priority mode, and send the network environment and production consumer resource capability information required for analysis to the decision support module

2. Decision support module: This module is divided into two parts. The static part can analyze a series of policies set by the user, and the dynamic part can analyze a series of policies according to the existing data transmission rate and processing speed

3. Data collection and sending module: the collected data objects are different, including real-time, batch and others. The module can collect data according to priority during data collection according to the final decision. In case of unfriendly environment, the cache module can be enabled to cache low priority data first.

4. Data cache module: the module can be a queue with in and out. According to the priority, the data with low priority will be sent to the queue first and then sent.

This disclosure aims to dynamically establish the sending strategy according to the network environment found in a Data Provider. When the network environment is poor, the approach can send the key information of one data record (such as the key data fields), in order to minimize the impact on the Data Analysis Platform.

The approach provides a dynamic data sending mechanism for vertical data prioritization. It contains various steps such as 1) Prioritize data vertically based on customer specifications and time decay; 2) a real-time network status metric is used to specify the real-time network status based on the environment's current network condition. Based on the previous data priority and network status, a data sending mechanism is performed based on the current real-time network status.

In one embodiment, a Vertical Data Priority Division Component, a Resource State Recognizer Component, and a Data Sending Decision Component work together to provide a dynamic vertical segmented data transmission process.

Regarding the Vertical Data Priority Division Component, first, a user or other entity (e.g., AI, etc.) specifies the data field (vertical data) classification policy, such as in a JSON Key-Value format shown below:
Data type
Data Fields
   Field name
   Field priority
      H—High priority (100)
      M—Medium priority (60)
      L—Low priority (30)

The Vertical Data Priority Division Component then splits the incoming data record vertically based on H(High priority), M (Middle priority), L (Low priority) data field classification policy and stores the high/middle/low data fields to the corresponding data stream.

Regarding the Resource State Recognizer Component, this component is used to calculate the RTNS (Real-time network score), which is used to specify the network state of the environment. The RTNS uses an Exponential Smoothing algorithm to train the historical data to determine the forecast network transmit rate.

Regarding the Data Sending Decision Component, this component includes two parts: Data sending decision and Priority assessment. Considering that the priority of some data will be degraded over time, the approach re-evaluates the priority of data based on time decay, this is included in the Priority assessment. Each time the approach decides whether to send only high priority key data according to the current network environment, and which part of the data is sent first according to the current data priority, this is the Data sending decision.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

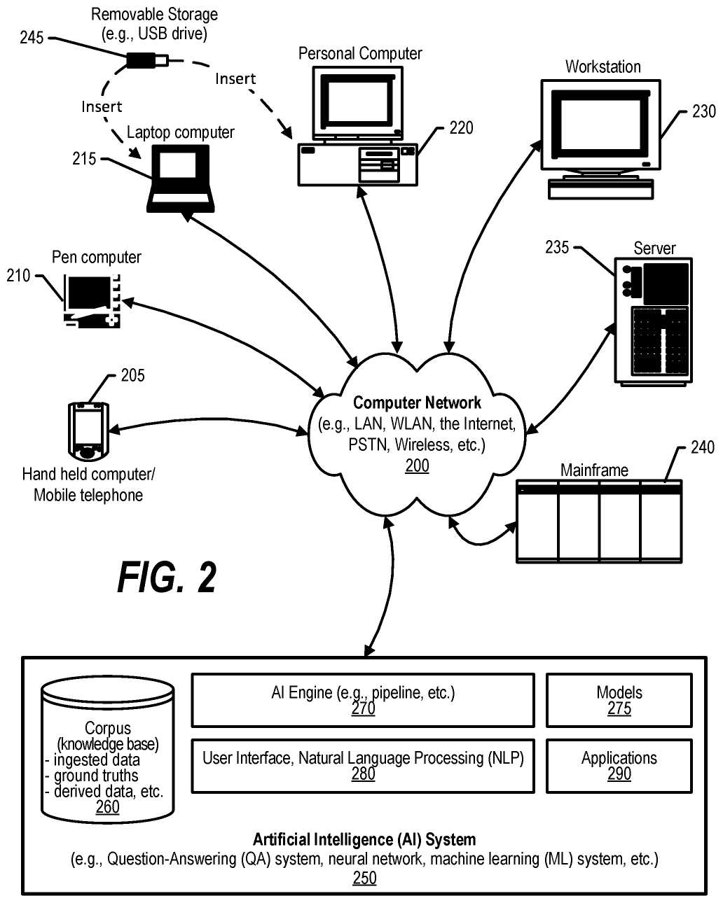

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 1 is a block diagram of a data processing system in which the methods described herein can be implemented. Computing environment 100 contains an example of an environment for the execution of at least some of the computer code involved in performing the inventive methods, such as shown in the description of block 195. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future.

In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A NETWORKED ENVIRONMENT is shown in FIG. 2. The networked environment provides an extension of the information handling system shown in FIG. 1 illustrating that the methods described herein can be performed on a wide variety of information handling systems that operate in a networked environment, depicted by computer network 200. Types of computer networks can include local area networks (LANs), wide area networks (WANs), the Internet, peer-to-peer networks, public switched telephone networks (PSTNs), wireless networks, etc. Types of information handling systems range from small handheld devices, such as handheld computer/mobile telephone 205 to large mainframe systems, such as mainframe computer 240. Examples of handheld computer 205 include smart phones, personal digital assistants (PDAs), personal entertainment devices, such as MP3 players, portable televisions, and compact disc players. Other examples of information handling systems include pen, or tablet, computer 210, laptop, or notebook, computer 215, personal computer 220, workstation 230, and server computer system 235. Other types of information handling systems that are not individually shown in FIG. 2 can also be interconnected other computer systems via computer network 200.

Many of the information handling systems include nonvolatile data stores, such as hard drives and/or nonvolatile memory depicted in FIG. 1. These nonvolatile data stores and/or memory can be included, or integrated, with a particular computer system or can be an external storage device, such as an external hard drive. In addition, removable nonvolatile storage device 245 can be shared among two or more information handling systems using various techniques, such as connecting the removable nonvolatile storage device 245 to a USB port or other connector of the information handling systems.

An ARTIFICIAL INTELLIGENCE (AI) SYSTEM is depicted at the bottom of FIG. 2. Artificial intelligence (AI) system 250 is shown connected to computer network 200 so that it is accessible by other computer systems 205 through 240. AI system 250 runs on one or more information handling systems (comprising one or more processors and one or more memories, and potentially any other computing device elements generally known in the art including buses, storage devices, communication interfaces, and the like) that connects AI system 250 to computer network 200. The network 200 may include multiple computing devices 104 in communication with each other and with other devices or components via one or more wired and/or wireless data communication links, where each communication link may comprise one or more of wires, routers, switches, transmitters, receivers, or the like. AI system 250 and network 200 may enable functionality, such as question/answer (QA) generation functionality, for one or more content users.

Other embodiments of AI system 250 may be used with components, systems, sub-systems, and/or devices other than those that are depicted herein.

AI system 250 maintains corpus 260, also known as a “knowledge base,” which is a store of information or data that the AI system draws on to solve problems. This knowledge base includes underlying sets of facts, ground truths, assumptions, models, derived data, and rules which the AI system has available in order to solve problems. In one embodiment, a content creator creates content in corpus 260. This content may include any file, text, article, or source of data for use in AI system 250. Content users may access AI system 250 via a network connection or an Internet connection to the network 200, and, in one embodiment, may input questions to AI system 250 that may be answered by the content in the corpus of data. As further described below, when a process evaluates a given section of a document for semantic content, the process can use a variety of conventions to query it from the AI system.

AI system 250 may be configured to receive inputs from various sources. For example, AI system 250 may receive input from the network 200, a corpus of electronic documents or other data, a content creator, content users, and other possible sources of input. In one embodiment, some or all of the inputs to AI system 250 may be routed through the network 200. The various computing devices on the network 200 may include access points for content creators and content users. Some of the computing devices may include devices for a database storing the corpus of data. The network 200 may include local network connections and remote connections in various embodiments, such that AI system 250 may operate in environments of any size, including local and global, e.g., the Internet. Additionally, AI system 250 serves as a front-end system that can make available a variety of knowledge extracted from or represented in documents, network-accessible sources and/or structured data sources. In this manner, some processes populate the AI system with the AI system also including input interfaces to receive knowledge requests and respond accordingly.

AI Engine 270, such as a pipeline, is an interconnected and streamlined collection of operations. The information works its way into and through a machine learning system, from data collection to training models. During data collection, such as data ingestion, data is transported from multiple sources, such as sources found on the Internet, into a centralized database stored in corpus 260. The AI system can then access, analyze, and use the data stored in its corpus.

Models 275 are the result of AI modeling. AI modeling is the creation, training, and deployment of machine learning algorithms that emulate logical decision-making based on the data available in the corpus with the system sometimes utilizing additional data found outside the corpus. AI models 275 provide AI system 250 with the foundation to support advanced intelligence methodologies, such as real-time analytics, predictive analytics, and augmented analytics.

User interface 280, such as Natural Language (NL) Processing (NLP) is the interface provided between AI system 200 and human uses. Semantic content is content based on the relation between signifiers, such as words, phrases, signs, and symbols, and what they stand for, their denotation, or connotation. In other words, semantic content is content that interprets an expression, such as by using NLP. Semantic data is stored as part of corpus 260. In one embodiment, the process sends well-formed questions (e.g., natural language questions, etc.) to the AI system. AI system 250 may interpret the question and provide a response to the content user containing one or more answers to the question. In some embodiments, AI system 250 may provide a response to users in a ranked list of answers. Other types of user interfaces (UIs) can also be used with AI system 250, such as a command line interface, a menu-driven interface, a Graphical User Interface (GUI), a Touchscreen Graphical User Interface (Touchscreen GUI), and the like.

AI applications 290 are various types of AI-centric applications focused on one or more tasks, operations, or environments. Examples of different types of AI applications include search engines, recommendation systems, virtual assistants, language translators, facial recognition and image labeling systems, and question-answering (QA) systems.

In some illustrative embodiments, AI system 250 may be a question/answering (QA) system, which is augmented with the mechanisms of the illustrative embodiments described hereafter. A QA type of AI system 250 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the I QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

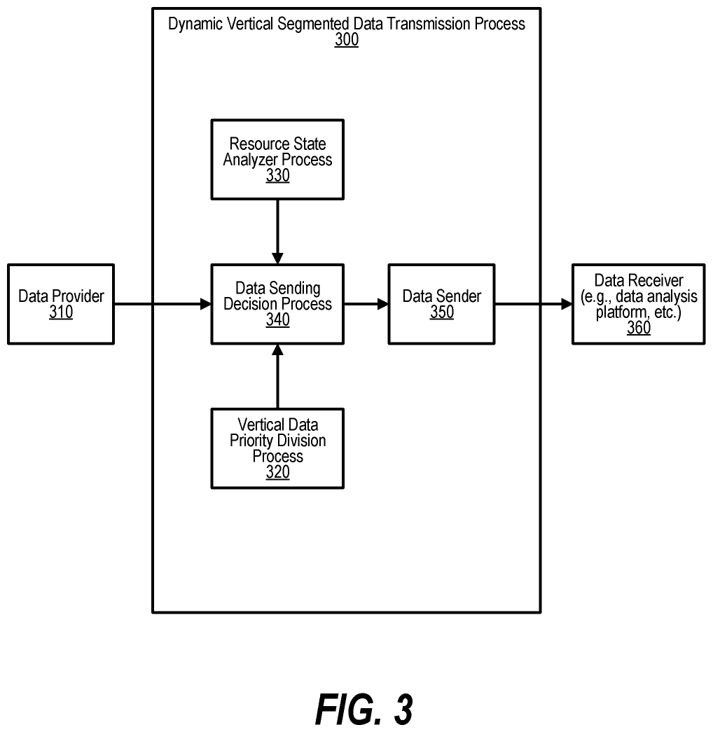

FIG. 3 is a component diagram depicting components used in a dynamic vertical segmented data transmission process. Dynamic vertical segmented data transmission process 300 receives incoming data records from data provider 310. Multiple data providers may send data records to process 300.

Vertical Data Priority Division Component 320 then splits the incoming data record vertically based on H(High priority), M (Middle priority), L (Low priority) data field classification policy and stores the high/middle/low data fields to the corresponding data stream.

Resource State Recognizer Component 330 is a component used to calculate the RTNS (Real-time network score), which is used to specify the network state of the environment. The RTNS uses an Exponential Smoothing algorithm to train the historical data to determine the forecast network transmit rate.

Data Sending Decision Component 340 is a component that includes two parts: a data sending decision process and a priority assessment process. Considering that the priority of some data will be degraded over time, the approach re-evaluates the priority of data based on time decay, this is included in the priority assessment process. Each time the approach decides whether to send only high priority key data according to the current network environment, and which part of the data is sent first according to the current data priority, this is performed by the data sending process.

The data sending process 340 utilizes data sender component 350 to send the data records as determined by the data sending process. The data sender sends, or transmits, the data records to data receiver 360, such as a data analysis platform or the like. The records sent by data sender 350 may be a portion of the incoming data record received from data provider based on the vertical data priority division process and resource state analyzer process that may have split the incoming data record by prioritized fields and, based on the resource state analyzer, sent a portion of the fields based on the priority of the fields, with higher-priority fields being preferably sent before lower-priority fields.

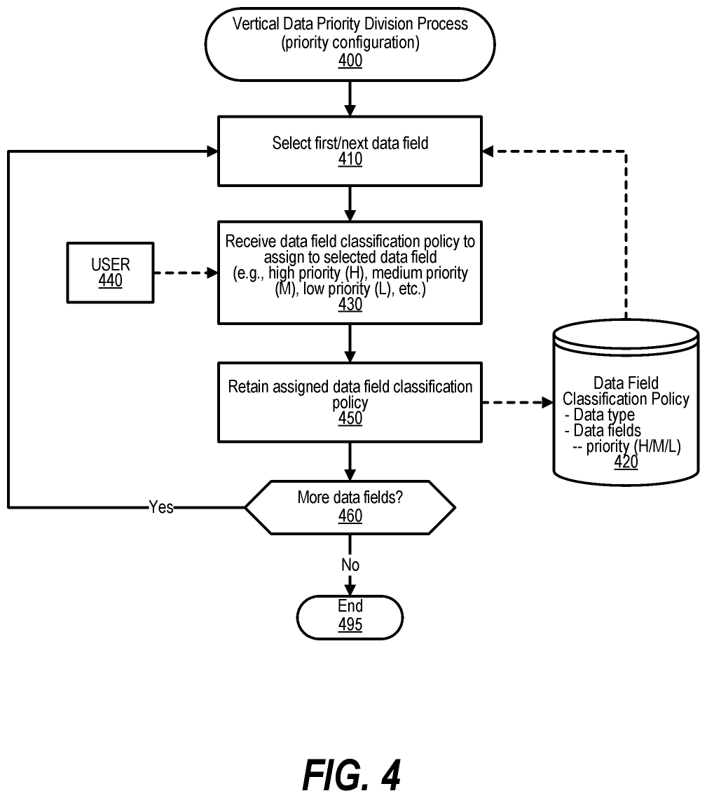

FIG. 4 is a flowchart depicting steps taken in a vertical data priority division process to configure data priority. FIG. 4 processing commences at 400 and shows the steps taken by a process that performs the Vertical Data Priority Division Process, and more particularly, the priority configuration aspects of vertical data priority division. At step 410, the process selects the first data field from a set of data field classification policies stored in data store 420.

The classification policy includes various metadata for various data fields that are expected to be encountered by the data handling processes. This metadata includes the data fields, the data types, and the priority to assign to each of the data fields (e.g., high, medium, low, etc.).

At step 430, the process receives the data field classification policy that includes the priority from entity 440. Entity 440 might be a human user of the process or another entity, such as a trained AI system, capable of assigning an appropriate priority. The priority provided by entity 440 is assigned to the selected data field (e.g., high priority (H), medium priority (M), low priority (L), etc.). At step 450, the process retains the assigned priority as part of the data field classification policy in data store 420 so that the priority is associated with the selected data field.

The process determines whether there are more data fields in data store 420 to process and assign priorities (decision 460). If there are more data fields to process, then decision 460 branches to the ‘yes’ branch which loops back to step 410 to select the next data field for processing from data store 420. This looping continues until there are no more data fields to process, at which point decision 460 branches to the ‘no’ branch exiting the loop. FIG. 4 processing thereafter ends at 495.

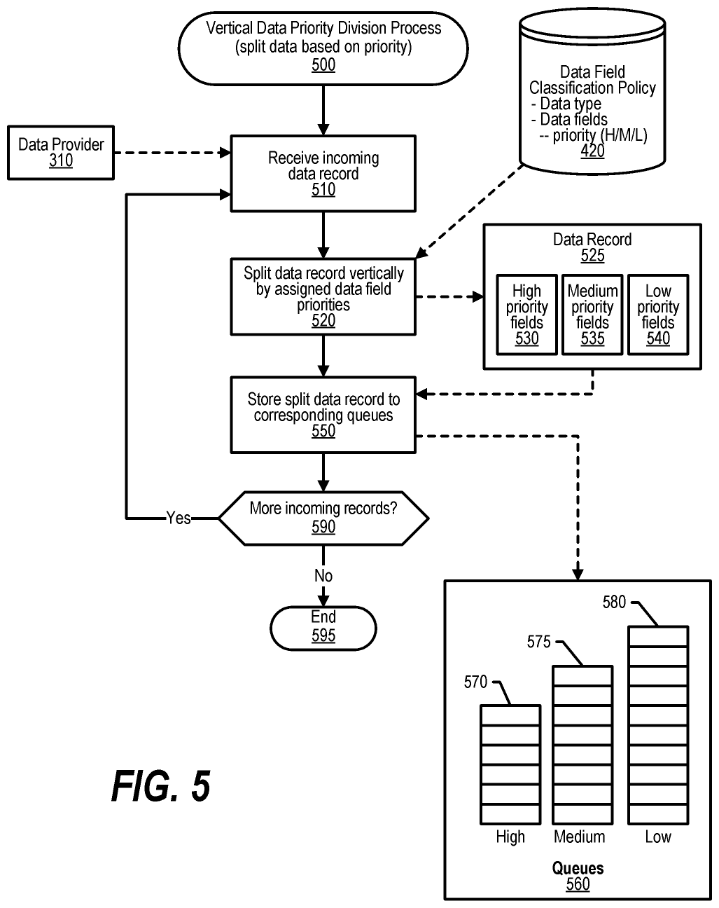

FIG. 5 is a flowchart depicting steps taken in a vertical data priority division process to split data based on priority. FIG. 5 processing commences at 500 and shows the steps taken by a process that performs the Vertical Data Priority Division Process, specifically the process that splits incoming data records based on priority of the fields within the record.

At step 510, the process receives an incoming data record from data provider 310. At step 520, the process splits the received data record vertically by the assigned data field priorities. The priorities assigned to the various fields in the data record are retrieved from the data field classification policy which was stored in data store 420. Data record 520 shows the incoming data record being split based on such priority. In one embodiment, the data record is split into high priority fields 530, medium priority fields 535, and low priority fields 540, however different numbers and granularity of priorities can be utilized based on the environment and implementation goals.

At step 550, the process stores the split data record to corresponding priority queues 560 with the high priority fields being stored in high priority queue 570, the medium priority fields being stored in medium priority queue 575, and the low priority fields being stored in low priority queue 580. Again, a different number of queues can be used based on the number of priority groupings utilized based on the environment and implementation goals.

The process determines whether there are more incoming records to process (decision 590). If there are more incoming records to process, then decision 590 branches to the ‘yes’ branch which loops back to step 510 to receive and process the next incoming record as described above. This looping continues until there are no more records to process (e.g., system shutdown, etc.), at which point decision 590 branches to the ‘no’ branch exiting the loop. FIG. 5 processing thereafter ends at 595.

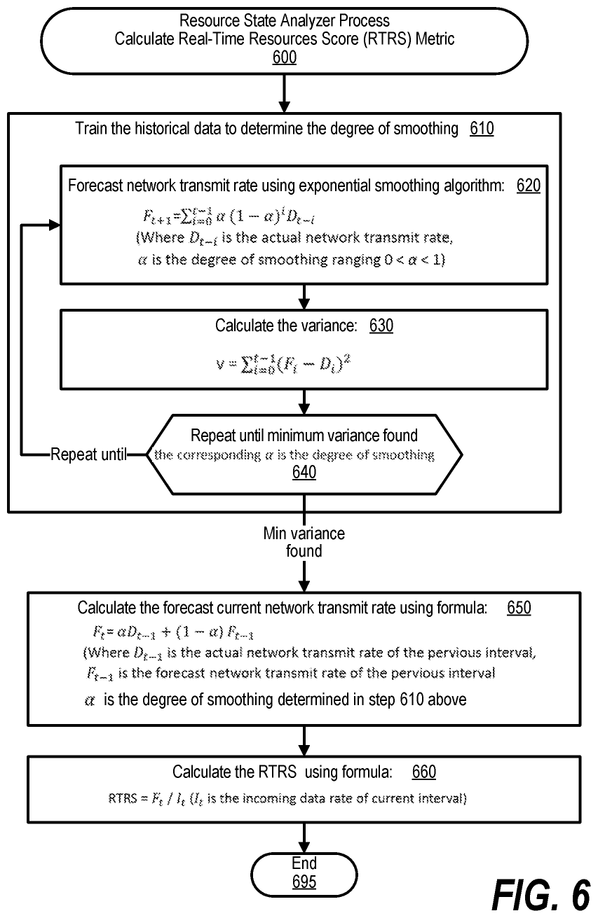

FIG. 6 is a flowchart depicting the steps taken by a resource state analyzer process to calculate a Real-Time Resources Score (RTRS) metric. FIG. 6 processing commences at 600 and shows the steps taken by a process that performs the Resource State Analyzer Process that calculates the Real-Time Resources Score (RTRS) Metric that is used to determine how busy a system is and which priority records should be sent.

At step 610, the process trains the historical data to determine the degree of smoothing that is needed by repeatedly performing steps 620 and 630 until a minimum variance is found. At step 630, the process forecasts the network transmit rate using an exponential smoothing algorithm that is shown in block 620. At step 630, the process calculates the variance using the equation shown in block 630.

The process determines whether a minimum variance has been found (decision 640). If a minimum variance has not yet been found, then decision 640 branches to the ‘repeat’ branch which loops back to step 620 to repeat forecasting the network transmit rate and calculating the resulting variance until a minimum variance is found. When a minimum variance is found, then decision 640 branches to the other branch exiting the loop.

At step 650, the process calculates the forecast current network transmit rate using formula shown in block 650 which utilizes the forecast network transmit rate and minimum variance found in step 610. At step 660, the process calculates the RTRS using the formula shown in block 660. FIG. 6 processing thereafter ends at 695.

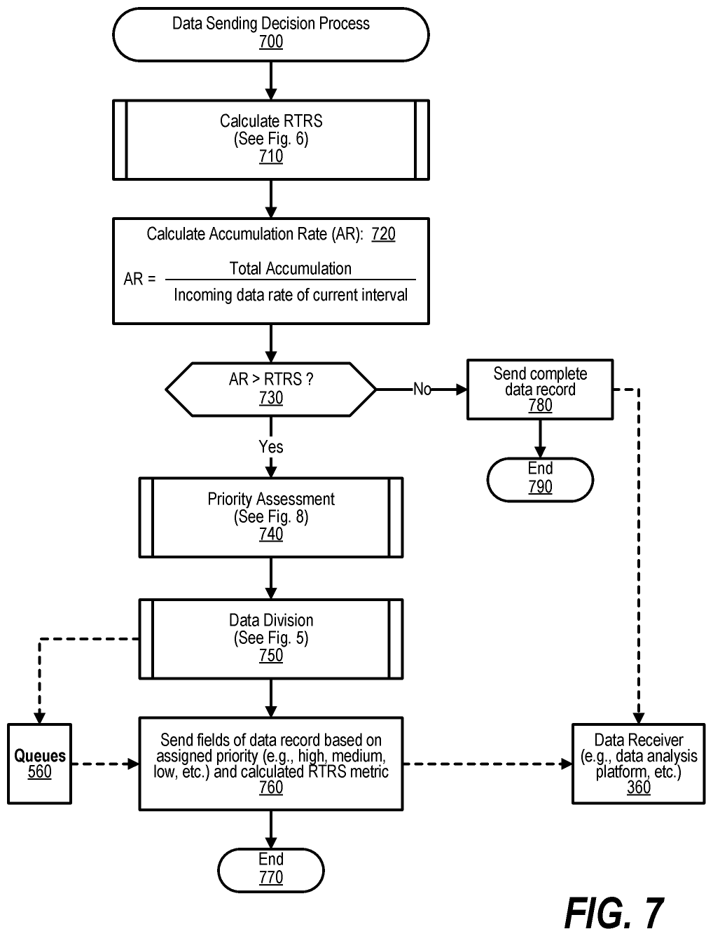

FIG. 7 is a flowchart depicting steps taken in a data sending decision process. FIG. 7 processing commences at 700 and shows the steps taken by a process that performs the Data Sending Decision Process. At predefined process 710, the process performs the Calculate RTRS routine (see FIG. 6 and corresponding text for processing details). At step 720, the process calculates the Accumulation Rate (AR). In one embodiment, the AR is calculated by dividing the total data accumulation by the incoming data rate of the current time interval.

The process determines as to whether the calculated accumulation rate is greater than the RTRS (AR>RTRS, decision 730). If the calculated accumulation rate is greater than the RTRS, then decision 730 branches to the ‘yes’ branch to perform steps 740 through 770 that send data fields to the data receiver based on the priority of such data fields. On the other hand, if not AR>RTRS, then decision 730 branches to the ‘no’ branch whereupon, at step 780, the complete data record is sent to data receiver 360 (as the system is not deemed to be having trouble processing data) and processing ends at 790.

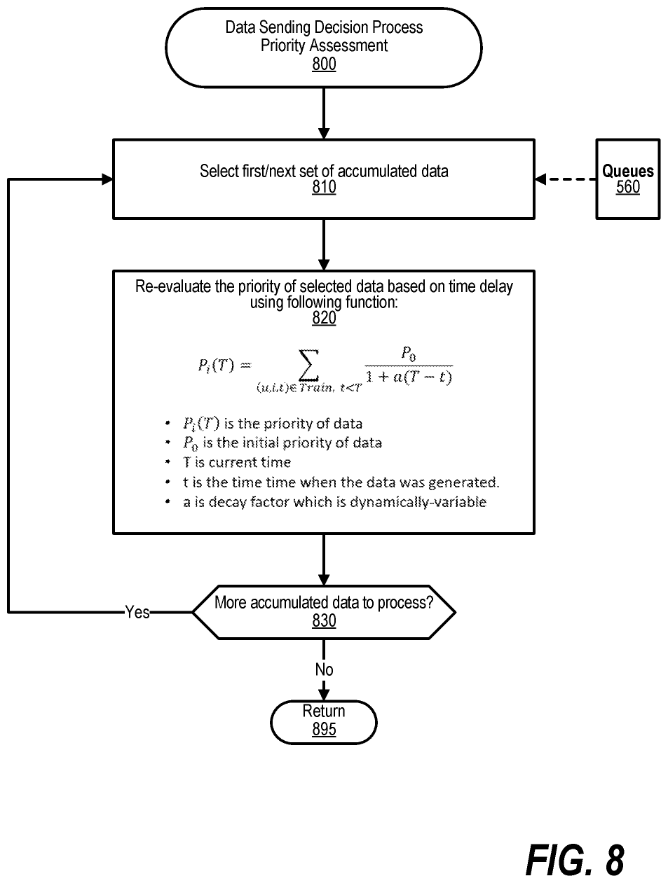

Steps 740 through 770 that send data fields to the data receiver based on the priority of such data fields. At predefined process 740, the process performs the Priority Assessment routine (see FIG. 8 and corresponding text for processing details). At predefined process 750, the process performs the Data Division routine (see FIG. 5 and corresponding text for processing details). This routine results in data being placed in priority queues 560 based on the respective priorities of the data fields in the data record.

At step 760, the process sends the fields of the incoming data record to data receiver 360 based on the assigned priority (e.g., high, medium, low, etc.) and the calculated RTRS metric. The RTRS metric is used to determine which priority queues are sent (e.g., only high priority queue, the high and medium priority queues, etc.). FIG. 7 processing thereafter ends at 770.

FIG. 8 is a flowchart depicting steps taken in a priority assessment process called by the data sending decision process. FIG. 8 processing commences at 800 and shows the steps taken by a process that performs the Data Sending Decision Process Priority Assessment. At step 810, the process selects the first set of accumulated data stored in the various data queues 560. At step 820, the process re-evaluates the priority of the selected data based on time delay using the function that is shown in block 820. This function may result in the priority of some data that is queued to be sent having its priority changed.

The process determines whether there is more accumulated data to process (decision 830). If there is more accumulated data to process, then decision 830 branches to the ‘yes’ branch which loops back to step 810 to select and process the next set of accumulated data as described above. This looping continues until all of the accumulated data has been processed, at which point decision 830 branches to the ‘no’ branch exiting the loop. FIG. 8 processing thereafter returns to the calling routine (see FIG. 7) at 895.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
receiving an incoming data record, wherein the incoming data record includes a plurality of data fields;
determining a current Real-Time Resources Score (RTRS), wherein the RTRS is a forecast of the information handling system's ability to handle incoming data transmissions;
in response to the RTRS being less than a current data accumulation rate:
assigning a priority to each of the plurality of data fields included in the incoming data record based on a priority assessment of the respective data fields; and
sending, to a data receiver, a subset of the plurality of data fields based on the priority assigned to the subset of data fields.

2. The method of claim 1 wherein the determining of the RTRS further comprises:
repeatedly calculating a forecast network transmission rate using an exponential smoothing algorithm and a variance between the forecast network transmission rate and an actual transmission rate until the variance is minimized, resulting in a final forecast network transmission rate and a final degree of smoothing;
calculating a forecast current network transmission rate using the final forecast network transmission rate, the final degree of smoothing, and the actual transmission rate; and
calculating the RTRS by dividing the forecast current network transmission rate by an incoming data rate of a current time interval.

3. The method of claim 2 further comprising:
calculating the current data accumulation rate by dividing a total data accumulation value by the incoming data rate of the current time interval.

4. The method of claim 1 further comprising:
dividing the incoming data record into a plurality of priority-based queues based on the priority assigned to the data fields.

5. The method of claim 4 further comprising:
comparing a difference between the RTRS and the current data accumulation rate to a threshold; and
sending, to the data receiver, the data fields included in one or more of the priority-based queues based on the comparing.

6. The method of claim 1 further comprising:
prior to receiving the incoming data record:
receiving, from an entity, one or more priority assignments corresponding, each of the priority assignments corresponding to one of the data fields;
retaining the priority assignments in a data store; and
wherein the assigning further comprises retrieving the retained priority assignments from the data store.

7. The method of claim 1 further comprising:
queuing the plurality of data fields in a plurality of priority-based queues based on the priority assigned to each of the data fields; and
re-evaluating the priority of the queued data fields based on a time delay, wherein the re-evaluating results in a different priority being assigned to at least one of the data fields.

8. An information handling system comprising:
one or more processors;
a memory coupled to at least one of the processors; and
a set of instructions stored in the memory and executed by at least one of the processors to perform actions comprising:
receiving an incoming data record, wherein the incoming data record includes a plurality of data fields;
determining a current Real-Time Resources Score (RTRS), wherein the RTRS is a forecast of the information handling system's ability to handle incoming data transmissions;
in response to the RTRS being less than a current data accumulation rate:
assigning a priority to each of the plurality of data fields included in the incoming data record based on a priority assessment of the respective data fields; and
sending, to a data receiver, a subset of the plurality of data fields based on the priority assigned to the subset of data fields.

9. The information handling system of claim 8 wherein the determining of the RTRS further comprises:
repeatedly calculating a forecast network transmission rate using an exponential smoothing algorithm and a variance between the forecast network transmission rate and an actual transmission rate until the variance is minimized, resulting in a final forecast network transmission rate and a final degree of smoothing;
calculating a forecast current network transmission rate using the final forecast network transmission rate, the final degree of smoothing, and the actual transmission rate; and
calculating the RTRS by dividing the forecast current network transmission rate by an incoming data rate of a current time interval.

10. The information handling system of claim 9 wherein the actions further comprise:
calculating the current data accumulation rate by dividing a total data accumulation value by the incoming data rate of the current time interval.

11. The information handling system of claim 8 wherein the actions further comprise:
dividing the incoming data record into a plurality of priority-based queues based on the priority assigned to the data fields.

12. The information handling system of claim 11 wherein the actions further comprise:
comparing a difference between the RTRS and the current data accumulation rate to a threshold; and
sending, to the data receiver, the data fields included in one or more of the priority-based queues based on the comparing.

13. The information handling system of claim 8 wherein the actions further comprise:
prior to receiving the incoming data record:
receiving, from an entity, one or more priority assignments corresponding, each of the priority assignments corresponding to one of the data fields;
retaining the priority assignments in a data store; and
wherein the assigning further comprises retrieving the retained priority assignments from the data store.

14. The information handling system of claim 8 wherein the actions further comprise:
queuing the plurality of data fields in a plurality of priority-based queues based on the priority assigned to each of the data fields; and
re-evaluating the priority of the queued data fields based on a time delay, wherein the re-evaluating results in a different priority being assigned to at least one of the data fields.

15. A computer program product comprising:
a computer readable storage medium comprising a set of computer instructions, the computer instructions performing actions comprising:
receiving an incoming data record, wherein the incoming data record includes a plurality of data fields;
determining a current Real-Time Resources Score (RTRS), wherein the RTRS is a forecast of the information handling system's ability to handle incoming data transmissions;
in response to the RTRS being less than a current data accumulation rate:
assigning a priority to each of the plurality of data fields included in the incoming data record based on a priority assessment of the respective data fields; and
sending, to a data receiver, a subset of the plurality of data fields based on the priority assigned to the subset of data fields.

16. The computer program product of claim 15 wherein the determining of the RTRS further comprises:
repeatedly calculating a forecast network transmission rate using an exponential smoothing algorithm and a variance between the forecast network transmission rate and an actual transmission rate until the variance is minimized, resulting in a final forecast network transmission rate and a final degree of smoothing;
calculating a forecast current network transmission rate using the final forecast network transmission rate, the final degree of smoothing, and the actual transmission rate; and
calculating the RTRS by dividing the forecast current network transmission rate by an incoming data rate of a current time interval.

17. The computer program product of claim 16 wherein the actions further comprise:
calculating the current data accumulation rate by dividing a total data accumulation value by the incoming data rate of the current time interval.

18. The computer program product of claim 15 wherein the actions further comprise:
dividing the incoming data record into a plurality of priority-based queues based on the priority assigned to the data fields.

19. The computer program product of claim 18 wherein the actions further comprise:
comparing a difference between the RTRS and the current data accumulation rate to a threshold; and
sending, to the data receiver, the data fields included in one or more of the priority-based queues based on the comparing.

20. The computer program product of claim 15 wherein the actions further comprise:
prior to receiving the incoming data record:
receiving, from an entity, one or more priority assignments corresponding, each of the priority assignments corresponding to one of the data fields;
retaining the priority assignments in a data store; and
wherein the assigning further comprises retrieving the retained priority assignments from the data store.
